(19) United States
(12) Patent Application Publication
(10) Pub. No.: US 2010/0291829 A1
(43) Pub. Date: Nov. 18, 2010

(54) METHOD FOR PRODUCING PLASMA DISPLAY PANEL

(76) Inventors: Yoshimasa TAKII, Osaka (JP); Yosuke Okui, Osaka (JP); Tomohiro Okumura, Osaka (JP); Masashi Goto, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/778,383

(22) Filed: May 12, 2010

(30) Foreign Application Priority Data
May 13, 2009 (JP) P2009-116420

(51) Int. Cl. H01J 9/26

(52) U.S. Cl. 445/25

(57) ABSTRACT

A method for producing a plasma display panel, the method comprising: (i) preparing a front panel and a rear panel, the front panel being a panel wherein an electrode A, a dielectric layer A and a protective layer are formed on a substrate A, and the rear panel being a panel wherein an electrode B, a dielectric layer B, a partition wall and a phosphor layer are formed on a substrate B; (ii) applying a glass frit material onto a peripheral region of the substrate A or B to form an annular glass frit sealing portion; (iii) opposing the front and rear panels with each other such that the annular glass frit sealing portion is interposed therebetween; (iv) supplying a dry gas into a space formed between the opposed front and rear panels; and (v) melting the annular glass frit sealing portion to cause the front and rear panels to be sealed wherein, in the step (i), the protective layer of the front panel is made from a metal oxide comprising at least two oxides selected from among magnesium oxide, calcium oxide, strontium oxide and barium oxide, said metal oxide having a peak between the minimum diffraction angle and the maximum diffraction angle which are selected among the diffraction angles given by respective ones of said at least two oxides in a specific orientation plane in X-ray diffraction analysis; and the step (v) is performed together with the step (iv) wherein the dry gas is supplied such that the front and rear panels do not deform until the point in time when a softening point of the annular glass frit sealing portion is reached.

### FIELD OF THE INVENTION

The present invention relates to a method for producing a plasma display panel which can be used as a display device.

### BACKGROUND OF THE INVENTION

A plasma display panel (hereinafter also referred to as “PDP”) has capabilities of high definition reproduction of pictures and larger screen, and thus has been commercialized as 100-inch class television sets. In recent years, it has been attempted to apply the PDP to high definition television sets with twice or more scan lines as those of the conventional NTSC TV format. Furthermore, there have been increasingly required for the PDP to have decreased power consumption for addressing the energy issue and to have lead-free material for meeting the environmental requirement.

The PDP is basically composed of a front panel and a rear panel. The front panel is disposed at the front such as it faces the viewer. Such front panel is generally provided with a glass substrate, display electrodes (each of which comprises a transparent electrode and a bus electrode), a dielectric layer and a protective layer. Specifically, (i) on one of principal surfaces of the glass substrate (e.g. sodium borosilicate glass substrate), the display electrodes are formed in a form of stripes; (ii) the dielectric layer is formed on the principal surface of the glass substrate so as to cover the display electrodes and serve as a capacitor; and (iii) the protective layer (e.g. MgO layer) is formed on the dielectric layer so as to protect the dielectric layer.

The rear panel is generally provided with a glass substrate, address electrodes, a dielectric layer, partition walls and phosphor layers (i.e. red(R), green(G) and blue(B) fluorescent layers). Specifically, (i) on one of principal surfaces of the glass substrate, the address electrodes are formed in a form of stripes; (ii) the dielectric layer is formed as a base dielectric layer on the principal surface of the glass substrate so as to cover the address electrodes; (iii) a plurality of partition walls (i.e. barrier ribs) are formed on the dielectric layer at equal intervals; and (iv) the phosphor layers are formed on the dielectric layer such that each of them is located between the adjacent partition walls.

The front panel and the rear panel are opposed to each other so that their electrodes are faced each other. The opposed front and rear panels are sealed together to form an airtight discharge space that is divided by the partition walls. The discharge space is filled with a discharge gas such as neon (Ne)-xenon (Xe) gas at a pressure of 400 Torr to 600 Torr. In operation of the PDP, ultraviolet rays are generated in the discharge cell upon selectively applying a voltage (i.e. voltage of picture signal), and thereby the phosphor layers capable of emitting different visible lights are excited. As a result, the excited phosphor layers respectively emit lights in red, green and blue colors, which will lead to an achievement of a full-color display.

The PDP is ordinarily operated by such a method that sets an initialization period during which charges on the wall are adjusted into a state that allows easy writing, a writing period during which writing electric discharge is carried out in accordance to the input picture signal, and a sustain period during which the pictures are displayed by causing sustain electric discharge in the discharge space wherein the writing operation has been done. Thus, the PDP displays gradation pictures by repeating a period (sub-field) that consists of the periods described above a plurality of times within a period (one field) that corresponds to one frame of picture.

In the PDP, the protective layer of the front panel generally serves to protect the dielectric layer from ion bombardment caused by electric discharge and also serves to release primary electrons for generating an address electric discharge. The protecting of the dielectric layer from ion bombardment is important in terms of preventing the discharge voltage from rising. Whereas, the releasing of the primary electrons for generating the address electric discharge is important in terms of preventing the discharge failure that may cause a blinking of the picture.

There are some attempts to increase the number of primary electrons released from the protective layer, and thereby suppressing the blinking of the picture. For example, some impurity is added to the MgO protective layer, or MgO particles are formed on the MgO protective layer. See Japanese Patent Kokai Publication No. 2002-260535, Japanese Patent Kokai Publication No. 11-339665, Japanese Patent Kokai Publication No. 2006-59779, Japanese Patent Kokai Publication No. 8-236028 and Japanese Patent Kokai Publication No. 10-334809 for example.

In a recent trend of television sets toward a higher definition of picture display, there is demand in the market for full HD (high definition) PDP (e.g. with progressive display with 1920 by 1080 pixels) with low cost, low power consumption and high brightness. The electron releasing characteristic of the protective layer determines a picture quality of the PDP, and thus it is important to control such electron releasing characteristic.

In order to display pictures with high definition, it is generally necessary to decrease the width of the pulse that is applied to the address electrodes during the writing period of the sub-field, since the number of pixels for writing increases despite the constant length of one field. However, there is a time lag called “delay in electric discharge” before electric discharge occurs in the discharge space after the rise of the voltage pulse, and thus a narrower pulse width results in lower probability of electric discharge being completed within the writing period. As a result, a lighting failure may be occurred, which leads to a deterioration of picture quality (e.g. a display blinking).

In order to achieve a higher definition and a lower power consumption of the PDP, it is necessary to not only suppress the discharge voltage from becoming higher but also suppress the lighting failure from being occurred in light of an improved picture quality.

Under the above circumstances, the present invention has been created. Thus, an object of the present invention is to provide a method for producing a PDP with a higher brightness display and a low voltage driving.

### SUMMARY OF THE INVENTION

In order to achieve the above object, the present invention provides a method for producing a plasma display panel, the method comprising:

(i) preparing a front panel and a rear panel, the front panel being a panel wherein an electrode A, a dielectric layer A and a protective layer are formed on a substrate A, and the rear panel being a panel wherein an electrode B, a dielectric layer B, a partition wall and a phosphor layer are formed on a substrate B;

(ii) applying a glass frit material onto a peripheral region of the substrate A or B to form an annular glass frit sealing portion (i.e. an annularly-shaped member for a subsequent sealing);

(iii) opposing the front and rear panels with each other such that the annular glass frit sealing portion is interposed therebetween;

(iv) supplying a dry gas into a space formed between the opposed front and rear panels (namely introducing the dry gas into the inner space of the panels i.e. into discharge space); and

(v) melting the annular glass frit sealing portion by a heating thereof to cause the front and rear panels to be sealed

wherein, in the step (i), the protective layer of the front panel is made from a metal oxide comprising at least two oxides selected from among magnesium oxide, calcium oxide, strontium oxide and barium oxide, said metal oxide having a peak diffraction angle between the minimum diffraction angle and the maximum diffraction angle which are selected among the diffraction angles given by respective ones of said at least two oxides constituting said metal oxide with respect to a specific orientation plane in X-ray diffraction analysis; and

the step (v) is performed together with the step (iv) wherein the dry gas is supplied such that the front and rear panels do not deform, until the point in time when a softening point of the annular glass frit sealing portion is reached upon the heating thereof.

The present invention is characterized in that the protective layer is formed of a specific component in light of favorability for the panel characteristics, and that an adverse effect attributable to such specific component is avoided or eliminated by the supply of the dry gas. The phrase “specific component in light of favorability for the panel characteristics” used herein refers to a metal oxide comprising at least two oxides selected from among magnesium oxide, calcium oxide, strontium oxide and barium oxide, said metal oxide having a peak diffraction angle between the minimum diffraction angle and the maximum diffraction angle which are selected among the diffraction angles given by respective ones of said at least two oxides constituting said metal oxide with respect to a specific orientation plane in X-ray diffraction analysis.

The method of the present invention is based on the supplying of the dry gas wherein the dry gas is introduced into the inner space formed between the opposed front and rear panels (namely the dry gas is forced to flow into the panel inner space i.e. into the discharge space). The introduction of the dry gas can increase a pressure of the panel inner space due to the airtight structure of the front and rear panels. The increased pressure may cause a deformation of the front and rear panels as shown in FIG. 1 (particularly see FIG. 1(b)), which may affect a flow state of the dry gas in the inner space of the panels. That is, the flow state of the dry gas in the panel inner space may vary due to “deformation of the front and rear panels”. Such a variation in the flow state of the dry gas in the inner space may cause an unevenness of the drive voltage or the display brightness in the display surface region of the obtained PDP. According to the present invention, therefore, the dry gas is introduced while preventing the deformation of the front and rear panels.

As will be apparent from the forgoing description, the phrase “the dry gas is introduced or supplied such that the front and rear panels do not deform” used in this specification and claims substantially means that the dry gas is forced to flow into the opposed front and rear panels so that the internal pressure of the opposed front and rear panel do not cause the deformation of the front panel and/or the rear panel. In this regard, the phrase “front and rear panels do not deform” substantially means that the deformation of the panel is suppressed within a small range of from about 0 to 0.1 mm, for example. More specifically, such phrase means that the displacement of the front panel or the rear panel at the center position thereof is suppressed within a small range of from 0 to 0.1 mm.

In view of the requirement that “the dry gas is introduced or supplied while preventing the deformation of the front and rear panels”, the method of the present invention is characterized in that the gas flow is supplied under such a condition that an unnecessarily high positive pressure does not build up in the space between the opposed front and rear panels. In a preferred embodiment of the method of the present invention, the flow of dry gas is introduced into the inner space between the opposed front and rear panels, so that the introduced dry gas leaks from the inner space due to a positive pressure therein. More specifically, the flow of the dry gas is introduced so as to generate the positive pressure of from 0 (excluding 0) to 350 Pa, preferably from 0 (excluding 0) to 100 Pa in the space formed between the opposed front and rear panels. As used in this specification and claims, the term “positive pressure” substantially means a differential pressure between “pressure in the opposed front and rear panels (i.e. internal pressure of the panels, namely discharge space pressure)” and “ambient pressure”. In other words, the positive pressure substantially equals to a difference between the internal pressure of the panels and the atmospheric pressure.

In another preferred embodiment of the step (iv), the dry gas is introduced through an opening formed in either the front panel or the rear panel. The dry gas to be introduced is preferably at least one kind of gas selected from a group consisting of inert gas (e.g. nitrogen gas), noble gas and dry air.

In accordance with the present invention, the adverse effect, which is attributable to the specific component of the protective layer for desired panel characteristics, is avoided or eliminated by the flow of the introduced dry gas. In other words, according to the method of the present invention, the flow of the dry gas can suppress an unnecessary reaction between the protective layer and the impurity gas upon the PDP producing process. Moreover even when a denatured layer has been formed in the surface region of the protective layer due to the above unnecessary reaction, the denatured layer can be easily removed by the flow of the dry gas. As a result, the present invention makes it possible to produce PDP with a higher brightness display and a lower voltage driving. Particularly according to the method of the present invention, the variation in the flow of the introduced dry gas is prevented, and thereby the variations in “suppression of the unnecessary reaction” and “removal of the denatured layer” can also be mitigated. As a result, the drive voltage unevenness and/or the display brightness unevenness over the display surface region is prevented. That is, in the PDP thus produced, the electric discharge characteristic is suppressed from varying among the discharge cells.

As for the PDP produced by the method of the present invention, it is made possible to improve the secondary electron releasing characteristic in the protective layer and decrease the electric discharge starting voltage even when the partial pressure of Xe gas of the discharge gas is increased for the purpose of improving the brightness. As a result, the PDP obtained by the present invention is excellent in terms of display performance with a higher brightness display and a lower voltage even when operated to display with high definition.

### BRIEF DESCRIPTION OF THE DRAWINGS

FIG. 1(a) is a perspective view schematically showing the front panel and the rear panel that are disposed to oppose each other, and FIG. 1(b) is a perspective view schematically showing a deformation of the opposed front and rear panels that may occur due to the supply of the dry gas.

FIG. 2(a) is a perspective view schematically showing a structure of PDP, and FIG. 2(b) is a sectional view schematically showing a front panel of PDP.

FIG. 3 is a plan view schematically showing an annular glass frit sealing portion, gas inlet section and gas flow (FIG. 3(a) shows an embodiment wherein a plurality of gas inlet openings are provided whereas FIG. 3(b) shows an embodiment wherein a plurality of gas inlet grooves are provided).

FIG. 4 is a perspective view schematically showing a form of partition walls.

FIG. 5 is a sectional view schematically showing an embodiment of a glass frit sealing portion and partition walls between the front panel and the rear panel.

FIG. 6 is a diagram showing the result of X-ray diffraction analysis with respect to the base film of the PDP protective layer.

FIG. 7 is a diagram showing the result of X-ray diffraction analysis with respect to the base film of the PDP protective layer (another component).

FIG. 8 is an enlarged diagram showing aggregated particles of the PDP protective layer.

FIG. 9 is a diagram showing a relationship between the delay in discharge of the PDP and calcium (Ca) concentration in the protective layer.

FIG. 10 is a diagram showing the outcomes of study as to the electron releasing performance and electric charge retaining performance of the PDP.

FIG. 11 is a diagram showing a relationship between the crystal particle size used in the PDP and the electron releasing characteristic.

FIG. 12 is a flowchart of operations associated with a method for producing a plasma display panel according to the present invention.

FIG. 13 is a diagram showing an example of temperature profile in a sealing and exhausting furnace.

FIG. 14 is a sectional view schematically showing a preferred embodiment of the method according to the present invention.

### DESCRIPTION OF REFERENCE NUMERALS

1 . . . Front panel
2 . . . Rear panel (Back panel)
10 . . . Substrate A of front panel
11 . . . Electrode A of front panel (Display electrode)
12 . . . Scan electrode
12a . . . Transparent electrode
12b . . . Bus electrode
13 . . . Sustain electrode
13a . . . Transparent electrode
13b . . . Bus electrode
14 . . . Black stripe (Light shielding layer)
15 . . . Dielectric layer A of front panel
16 . . . Protective layer
16a . . . Base film of protective layer
16b . . . Crystal particles disposed on base film of protective layer
16b′ . . . Aggregated particles composed of a plurality of crystal particles
20 . . . Substrate B of rear panel
21 . . . Electrode B of rear panel (Address electrode)
22 . . . Dielectric layer B of rear panel
23 . . . Partition wall (Barrier rib)
23a . . . Partition wall extending along longer side
23b . . . Partition wall extending along shorter side
25 . . . Phosphor layer (Fluorescent layer)
30 . . . Discharge space
32 . . . Discharge cell
70 . . . Clip
86 . . . Glass frit sealing portion
86′ . . . Glass frit sealing portion for blocking gas inlet opening
86″ . . . Glass frit sealing portion after sealing process
92 . . . Through hole (gas inlet opening)
92a . . . Plurality openings for gas inlet
92b . . . Plurality grooves for gas inlet
94 . . . Valve (Valve for dry gas)
95 . . . Valve (Valve for exhausting)
96 . . . Valve (Valve for discharge gas)
A . . . Dry gas

### DETAILED DESCRIPTION OF THE PREFERRED EMBODIMENT

With reference to the accompanying drawings, a method for producing a plasma display panel according to the present invention will be described in detail. Various components or elements are shown schematically in the drawings with dimensional proportions and appearances that are not necessarily real, which are merely for the purpose of making it easy to understand the present invention.

### [Construction of Plasma Display Panel]

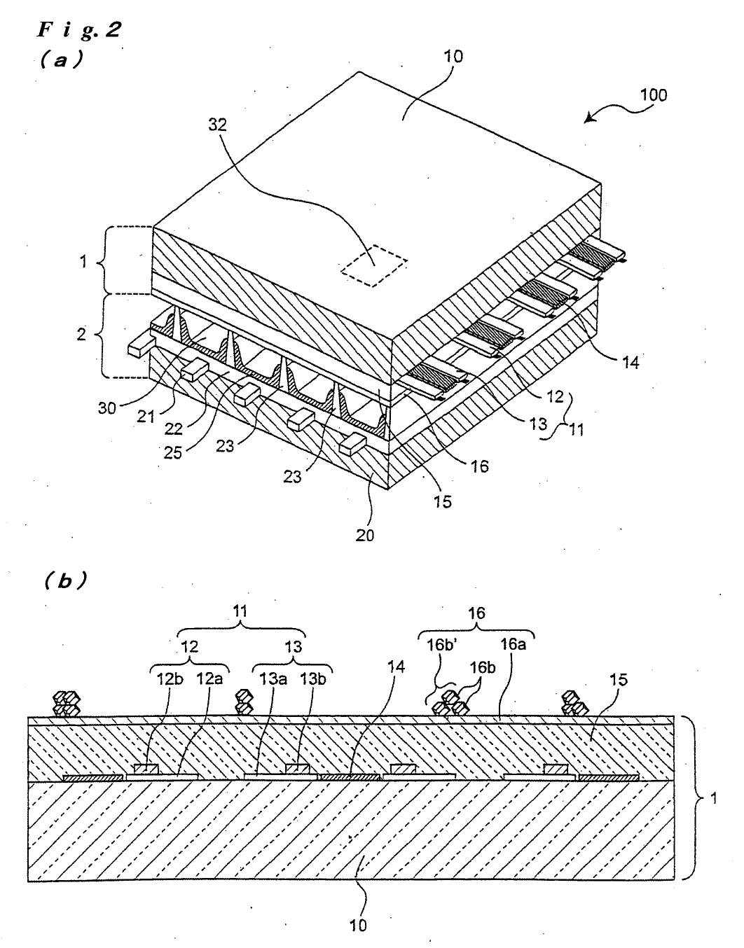

First, a plasma display panel, which can be finally obtained by the method of the present invention, is described below. FIG. 2(a) schematically shows a perspective and sectional view of the construction of PDP. FIG. 2(b) schematically shows a sectional view of the front panel of the PDP.

As shown in FIG. 2(a), the PDP (100) of the present invention comprises a front panel (1) and a rear panel (2) opposed to each other. The front panel (1) is generally provided with a substrate A (10), electrodes A (11), a dielectric layer A (15) and a protective layer (16) The rear panel (2) is generally provided with a substrate B (20), electrodes B (21), a dielectric layer B (22), partition walls (23) and phosphor layers (25).

As for the front panel (1), (i) on one of principal surfaces of the substrate A (10) , the electrodes A (11) are formed in a form of stripes; (ii) the dielectric layer A (15) is formed on the principal surface of the substrate A (10) so as to cover the electrodes A (11); and (iii) the protective layer (16) is formed on the dielectric layer A (15) so as to protect the dielectric layer A (15). As for the rear panel (2), (i) on one of principal surfaces of the substrate B (20), the electrodes B (21) are formed in a form of stripes; (ii) the dielectric layer B (22) is formed on the principal surface of the substrate B (20) so as to cover the electrodes B (21); (iii) a plurality of partition walls (23) are formed on the dielectric layer B (22) at equal intervals; and (iv) the phosphor layers (25) are formed on the dielectric layer B (22) such that each of them is located between the adjacent partition walls (23). As illustrated, the front panel (1) and the rear panel (2) are opposed to each other. The opposed front and rear panels are sealed along their peripheries by a sealing material (not shown). As the sealing material, a material consisting mainly of a glass frit with a low melting point may be used. Between the front panel (1) and the rear panel (2), there is formed a discharge space (30) filled with a discharge gas (helium, neon or the like) under a pressure preferably from 20 kPa to 80 kPa.

The PDP (100) of the present invention will be described below in much more detail. As described above, the front panel (1) of the PDP (100) according to the present invention comprises the substrate A (10), the electrodes A (11), the dielectric layer A (15) and the protective layer (16). The substrate A (10) is a transparent substrate with an electrical insulating property. The thickness of the substrate A (10) may be in the range of from about 1.0 mm to about 3 mm. The substrate A (10) may be a float glass substrate produced by a floating process. The substrate A (10) may also be a soda lime glass substrate or a borosilicate glass substrate. A plurality of electrodes A (11) are formed in a pattern of parallel stripes on the substrate A (10). It is preferred that the electrode A (11) is a display electrode which is composed of a scan electrode (12) and a sustain electrode (13). Each of the scan electrode (12) and the sustain electrode (13) is composed of a transparent electrode (12a, 13a) and a bus electrode (12b, 13b). The transparent electrode (12a, 13a) may be an electrically conductive film made of indium oxide (ITO) or tin oxide (SnO₂) in which case the visible light generated from the phosphor layer can go through the film. The bus electrode (12b, 13b) is formed on the transparent electrode (12a, 13a), and may be mainly made of silver so that it serves to reduce a resistance of the display electrode and give an electrical conductivity in the longitudinal direction for the transparent electrode. Thickness of the transparent electrodes (12a, 13a) is preferably in the range of from about 50 nm to about 500 nm whereas thickness of the bus electrodes (12b, 13b) is preferably in the range of from about 1 μm to about 20 μm. As shown in FIG. 2(a), black stripes (14) (i.e. light shielding layer) may also be additionally formed on the substrate A (10).

The dielectric layer A (15) is provided to cover the electrodes A (11) on the surface of the substrate A (10). The dielectric layer A (15) may be an oxide film (e.g. silicon oxide film). Such oxide film can be formed by applying a dielectric material paste consisting mainly of a glass component and a vehicle component (i.e. component including a binder resin and an organic solvent), followed by heating the dielectric material paste. On the dielectric layer A (15), there is formed the protective layer (16) whose thickness is for example from about 0.5 μm to about 1.5 μm. The protective layer (16) may be made of magnesium oxide (MgO), and serves to protect the dielectric layer A (15) from a discharge impact (more specifically, from the impact of ion bombardment attributable to the plasma).

As described above, the rear panel (2) of the PDP according to the present invention comprises the substrate B (20), the electrodes B (21), the dielectric layer B (22), the partition walls (23) and the phosphor layers (25). The substrate B (20) is preferably a transparent substrate with an electrical insulating property. The thickness of the substrate B (20) may be in the range of from about 1.0 mm to about 3 mm. The substrate B (20) may be a float glass substrate produced by a floating process. The substrate B (20) may also be a soda lime glass substrate or a borosilicate glass substrate. Furthermore, the substrate B (20) may also be a substrate made of various ceramic materials. A plurality of the electrodes B (21) are formed in a pattern of parallel stripes on the substrate B (20). For example, the electrode B (21) is an address electrode or a data electrode (whose thickness is for example about 1 μm to about 10 μm). The electrodes B (21) serve to cause the discharge to occur selectively in particular discharge cells. The electrodes B (21) can be formed from an electrically conductive paste including silver as a main component.

The dielectric layer B (22) is provided to cover the electrodes B (21) on the surface of the substrate B (20). The dielectric layer B (22) is generally referred to as a base dielectric layer. The dielectric layer B (22) may be an oxide film (e.g. silicon oxide film). Such oxide film can be formed by applying a dielectric material paste consisting mainly of a glass component and a vehicle component (i.e. component including a binder resin and an organic solvent), followed by heating the dielectric material paste. Thickness of the dielectric layer B (22) is preferably in the range of from about 5 μm to about 50 μm. On the dielectric layer B (22), there is formed the phosphor layers (25R, 25G, 25B) whose thickness is for example from about 5 μm to about 20 μm. The phosphor layers (25R, 25G, 25B) serve to convert the ultraviolet ray emitted due to the discharge into visual light ray. The three kinds of the phosphor layer (25R, 25G, 25B) constitute a basic unit wherein three kind of fluorescent material layers, each of which is separated from each other by the partition walls (23), are respectively capable of emitting red, green and blue lights. The partition walls (23) are provided in a form of stripes or in two pairs of perpendicularly intersecting parallel lines on the dielectric layer B (22). The partition walls (23) serve to divide the discharge space into cells, each of which is allocated to one of the address electrodes (21). The partition walls (23) can be made from a paste containing of a glass power, a vehicle component, a filler, etc.

In the PDP (100), the front panel (1) and the rear panel (2) are opposed to each other such that the display electrode (11) of the front panel (1) and the address electrode (21) of the rear panel (2) perpendicularly intersect with each other. Between the front panel (1) and the rear panel (2), there is formed a discharge space (30) filled with a discharge gas. With such a construction of the PDP (100), the discharge space (30) is divided by the partition walls. Each of the divided discharge space (30), at which the display electrode (11) and the address electrode (21) intersect with each other, serves as a discharge cell (32). The discharge gas is caused to discharge by applying a picture signal voltage selectively to the display electrodes from an external drive circuit. The ultraviolet ray generated due to the discharge of the discharge gas can excite the phosphor layers so as to emit visible lights of red, green and blue colors therefrom, which will lead to an achievement of a display of color images or pictures.

### [General Method for Production of PDP]

Next, a typical production of the PDP (100) will be briefly described. In this specification, unless otherwise mentioned, raw materials (i.e. paste material) of the constituent members or parts may be the same as those used in the conventional PDP production.

The typical production of the PDP (100) comprises a step for forming the front panel (1) and a step for forming the rear panel (2). As for the step for forming the front panel (1), not only the display electrode (11) composed of the scan electrode (12) and the sustain electrode (13) but also and the light shielding layer (14) is firstly formed on the glass substrate (10). In the forming of each of the scan electrode (12) and the sustain electrode (13), a transparent electrode (12a, 13a) and a bus electrode (12b, 13b) can be formed through a patterning process such as a photolithography wherein an exposure and a developing are carried out. The transparent electrode (12a, 13a) can be formed by a thin film process. The bus electrode (12b, 13b) can be formed by drying a silver (Ag)-containing paste at a temperature of about 100 to 200° C., followed by a calcining treatment thereof at a temperature of about 400 to 600° C. The light shielding layer (14) can also be formed in a similar way. Specifically, a light shielding layer precursor can be formed in a desired form by a screen printing process wherein a black pigment-containing paste is printed, or by a photolithography process wherein a black pigment-containing paste is applied over the substrate followed by exposure and developing thereof. The resulting light shielding layer precursor is finally calcined to form the light shielding layer therefrom. After the formation of the display electrode (11) and the light shielding layer (14), the dielectric layer A (15) is formed. Specifically, a layer of dielectric material paste is firstly formed on the substrate A (10) so as to cover the scan electrodes (12), sustain electrodes (13) and the light shielding layer (14). This formation of the paste layer can be performed by applying a paste of dielectric material consisting mainly of a glass component (a material including SiO₂, B₂O₃, etc.) and a vehicle component with a die coating or printing process. The dielectric material paste that has been applied is left to stand for a predetermined period of time, so that the surface of the dielectric material paste becomes flat. Then the layer of dielectric material paste is calcined to form the dielectric layer A (15) therefrom. After the formation of the dielectric layer A (15), the protective layer (16) is formed on the dielectric layer A (15). In a general sense, the protective layer (16) can be formed by a vacuum deposition process, a CVD process, a sputtering process or the like.

By performing the above steps or operations as described above, the front panel (1) of the PDP can be finally obtained wherein the electrodes A (the scan electrodes (12) and the sustain electrodes (13)), the dielectric layer A (15) and the protective layer (16) are formed on the substrate A (10).

The rear panel (2) is produced as follows. First, a precursor layer for address electrode is formed by screen printing a silver(Ag)-containing paste onto a substrate B (20) (i.e. glass substrate). Alternatively, the precursor layer can be formed by a photolithography process in which a metal film consisting of silver as a main component is formed over the entire surface of the substrate and is subjected to an exposure and development treatments. The resulting precursor layer is then calcined at a predetermined temperature (for example, about 400° C. to about 600° C.), and thereby the address electrodes (21) are formed. The address electrodes (21) may be formed by applying a photoresist onto a 3-layered thin film of chromium/copper/chromium, followed by pattering it with a photolithography and wet etching process. Subsequent to the formation of the electrodes (21), a dielectric layer B (22) (i.e. so-called “base dielectric layer”) is formed over the substrate B (20) so as to cover the address electrodes (21). To this end, a dielectric material paste that mainly contains a glass component (e.g. a glass material made of SiO₂, B₂O₃, or the like) and a vehicle component is applied by a die coating process or the like, so that a dielectric paste layer is formed. The resulting dielectric paste layer is then calcined to form the dielectric layer B (22) therefrom. Subsequently, the partition walls (23) are formed at a predetermined pitch. To this end, a material paste for partition wall is applied onto the dielectric layer B (22) and then patterned in a predetermined form to obtain a partition wall material layer. The partition wall material layer is then heated to form the partition walls therefrom. Specifically, a material paste containing a low melting point glass material, a vehicle component, filler and the like as the main components is applied by a die-coating process or a screen printing process, and then the applied material paste is dried at a temperature of from about 100° C. to 200° C. The dried material is subsequently patterned in a predetermined form by performance of a photolithography process wherein an exposure and a development thereof are carried out. The resulting patterned material is subsequently calcined at a temperature of from about 400° C. to 600° C., and thereby the partition walls are formed therefrom. Alternatively, the partition walls (23) can also be formed by drying a partition wall material film formed by a screen printing, patterning it with an exposure and development of a photosensitive resin-containing dry film, machining the wall material film with a sand blast, peeling off the dry film and finally calcining the wall material film. After the formation of the partition walls (23), the phosphor layer (25) is formed. To this end, a phosphor material paste is applied onto the dielectric layer (22) provided between the adjacent partition walls (23), and subsequently the applied phosphor material paste is calcined. Specifically, the phosphor layer (25) is formed by applying a material paste containing a fluorescent powder, a vehicle component and the like as the main components by performance of a die coating, printing, dispensing or ink-jet process, followed by drying the applied paste at a temperature of about 100° C.

By performing the above steps or operations as described above, the rear panel (2) of the PDP can be finally obtained wherein the electrodes B (the address electrodes 21), the dielectric layer B (22), the partition walls (23) and the phosphor layer (25) are formed on the substrate B (20).

The front panel (1) and the rear panel (2) are disposed to oppose each other such that the display electrode (11) and the address electrode (21) perpendicularly intersect with each other. The front panel (1) and the rear panel (2) are then sealed with each other along their peripheries by the glass frit. The discharge space (30) formed between the front panel (1) and the rear panel (2) is evacuated and is then filled with a discharge gas (e.g. helium, neon or xenon) This results in a completion of the PDP production.

### [Method of the Present Invention]

The present invention is characterized by the process up to the panel sealing following the formation of the front and rear panels, among the above production steps or operations of the PDP. Each step of the present invention will be now described, followed by the description of the characterized matters of the present invention.

In the method of the present invention, the step (i) is firstly performed. In other words, there is provided the front panel wherein the electrodes A, the dielectric layer A and the protective layer are formed on the substrate A, and also the rear panel wherein the electrodes B, the dielectric layer B, the partition walls and the phosphor layers are formed on the substrate B. The provision of the front panel and the rear panel has been described above in “General Method for Production of PDP”, and thus is omitted here to avoid repetition. It should be however noted that the protective layer is made of a metal oxide comprising at least two oxides selected from among magnesium oxide, calcium oxide, strontium oxide and barium oxide. In particular, the metal oxide of the protective layer has a peak diffraction angle between the minimum diffraction angle and the maximum diffraction angle which are selected among the diffraction angles given by respective ones of said at least two oxides constituting said metal oxide with respect to a specific orientation plane of X-ray diffraction analysis of the metal oxide. Use of such metal oxide for the protective layer can decrease the electric discharge starting voltage and decrease the delay in electric discharge, thus resulting in a stable electric discharge. It should be noted that such favorable metal oxide is highly reactive with water and impurity gas (e.g. carbon dioxide). Namely, the use of such metal oxide as a components of the protective layer may, in general, cause the protective layer to react with water and carbon dioxide, thus resulting in a deterioration of the electric discharge characteristic. In this regard, the present invention avoids such undesirable reaction since a cleanness of the protective layer is achieved by the supply of the dry gas (as will be described later).

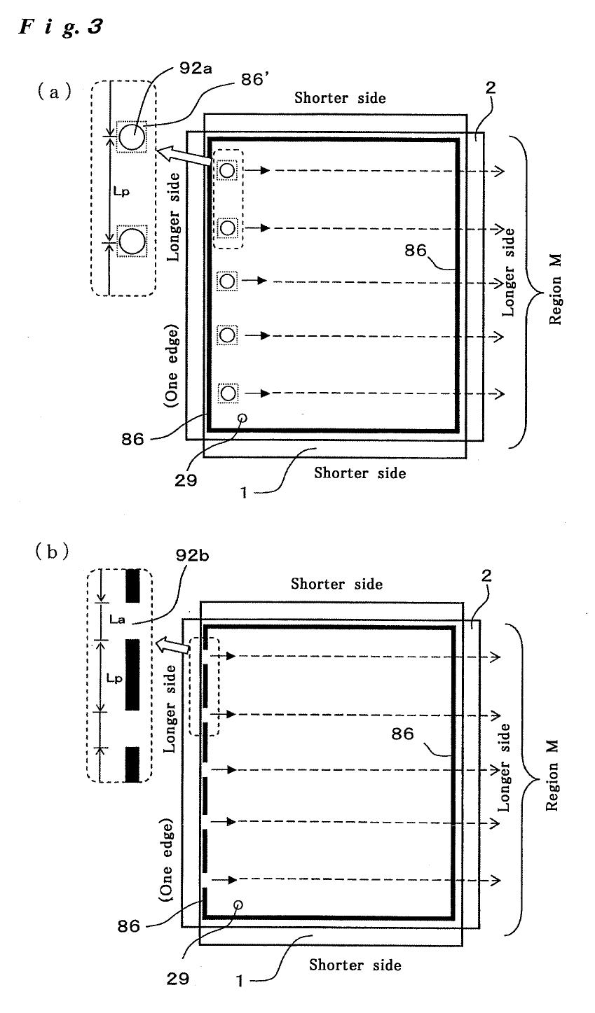

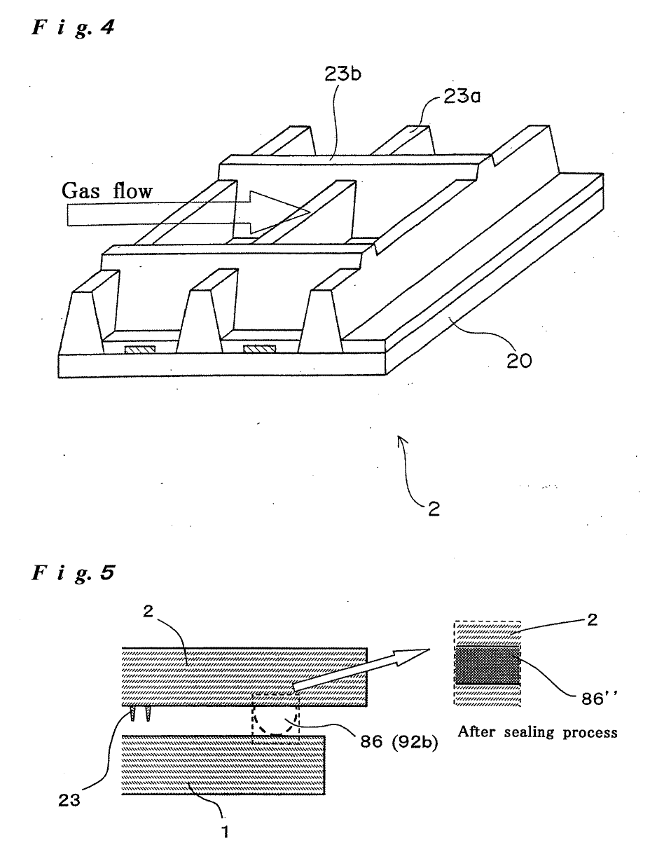

In a case of the introduction or supply of the gas via an opening of the panel upon the subsequent step (iv), an opening for gas inlet (or a through hole) is preliminarily formed in the front panel or the rear panel. For example, the gas inlet opening can be formed by drilling or laser machining process of the front or rear panel. In a case of the gas inlet opening of the rear panel, it is preferable to form the opening after a phosphor material paste is applied and dried. The gas inlet opening may have any shape, form and size as long as it enables to introduce the gas therethrough into the space between the opposed front and rear panels. Just as example, the gas inlet opening may be round opening with diameter of about 1 to 20 mm. Number of the gas inlet opening is not limited to one, and thus a plurality of the openings may be provided. In this case, pitch Lp of the gas inlet openings (92a) shown in FIG. 3(a) is, for example, roughly from 50 to 500 mm while it may vary depending on the substrate size or other factors. It is preferred that the plurality of the gas inlet openings (92a) are disposed along the longer side of the front panel (1) or rear panel (2) as shown in FIG. 3. The gas supply through the longer side makes it possible to decrease the length of the gas streamline between the opposed front and rear panels than a case of the gas supply through the shorter side, which will lead to an achievement of more uniform removal of the denatured layer from the surface region of the protective layer. Also as shown in FIG. 4, the partition walls are formed in a grating configuration wherein the partition walls (23a) extending along the longer side of the panel are lower in height than the partition walls (23b) extending along the shorter side of the panel. As a result, the introduction of the gas through the longer side enables the gas to flow more effectively between the front and rear panels. The word “plurality” regarding the phrase “plurality of the gas inlet opening” substantially means a number of from 2 to 16.

Subsequent to the step (i) of the method of the present invention, the step (ii) is performed. Namley, a glass frit material is applied onto a peripheral region of the substrate A or the substrate B so as to form an annular glass frit sealing portion. More specifically, the annular glass frit sealing portion is formed so that a continuous ring form thereof is formed around the overlapped area of the opposed front and rear panels. The glass frit sealing portion serves to seal the peripheries of the front and rear substrates in the subsequent sealing step (v). In a case where the gas inlet opening is provided in the front or rear panel, the annular glass frit sealing portion is formed outside the gas inlet opening in the substrate of the front or rear panels. In a case where a spontaneous cease of the gas supply is intended during the sealing of the panels, it is preferable to provide an additional glass frit sealing portion (reference numeral 86′ in FIG. 3(a)) in the vicinity of the gas inlet opening (92a) so that the gas inlet opening can be blocked (namely, the molten glass frit sealing portion 86′ can block the gas inlet opening 92a upon the sealing operation). There is no limitation to the kind of glass frit material. Any suitable materials, which are used in the conventional PDP production, may be used. For example, a glass frit material consisting mainly of a glass material with a low melting point (e.g. a glass material based on lead oxide—boron oxide—silicon borate or based on lead oxide—boron oxide—silicon borate—zinc oxide) may be used. The glass frit material may also contain a vehicle component in order to make it easier to apply. For example, the glass frit material may be prepared by adding a vehicle component consisting of a resin such as methyl cellulose, nitrocellulose or the like and a solvent such as a-terpineol or aluminum acetate, to a sealing material made by uniformly mixing a low melting point glass powder based on PbO, P₂O₅—SnO or Bi₂O₃ and a filler, and stirring the mixture to form a slurry. The glass frit material preferably has a form of paste (with viscosity being in the range of from about 50 to 200 Pa·s at the normal temperature of about 23° C.) so as to apply it to form the annular glass frit sealing portion. However, the annular glass frit sealing portion may also be alternatively provided by disposing a solid glass frit material. The annular glass frit sealing portion, which is located along the peripheral region of the substrate A or the substrate B, preferably has a thickness of about 200 to 600 μm and a width of about 3 to 10 mm.

The annular sealing section may also be made of a frit material consisting mainly of bismuth oxide or vanadium oxide. The frit material based on the bismuth oxide can be prepared, for example, by adding a filler consisting of oxides such as Al₂O₃, SiO₂ and/or cordierite to a glass material based on Bi₂O₃—B₂O₃-Ro-MO (“R” represents any one of Ba, Sr, Ca and Mg, and also “M” represents any one of Cu, Sb and Fe). The frit material based on vanadium oxide can be prepared by adding a filler consisting of oxide such as Al₂O₃, SiO₂ and/or cordierite to a glass material based on V₂O₅—Ba—TeO—WO.

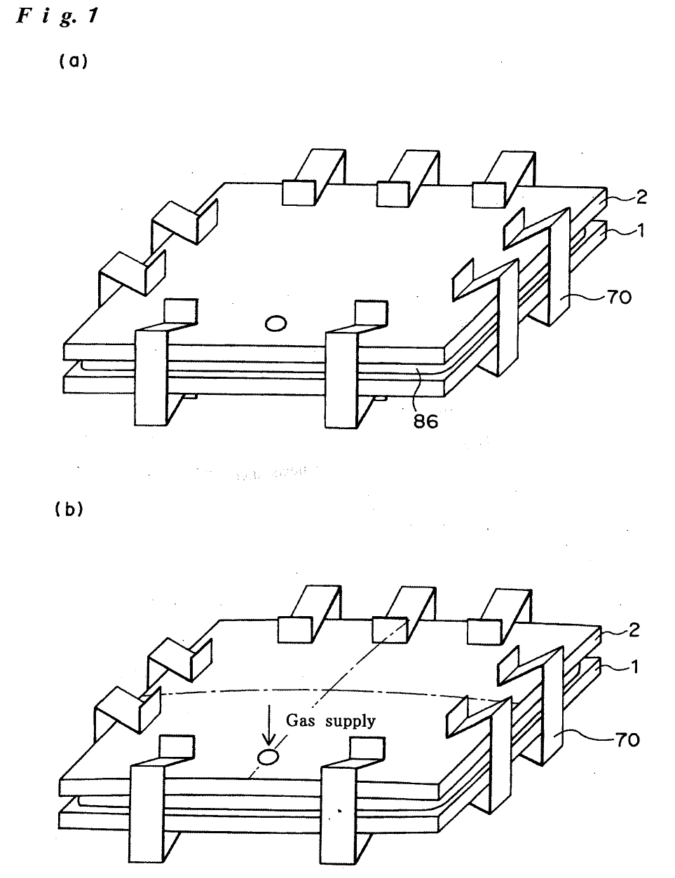

Subsequent to the step (ii) of the method of the present invention, the step (iii) is performed. Namely, the front panel and the rear panel are disposed to oppose each other, so that the annular glass frit sealing portion is located between the substrate A and the substrate B (see, for example FIG. 1(a)). In other words, the front panel and the rear panel are disposed to oppose each other so that the protective layer and the phosphor layer face each other. More specifically, the front panel and the rear panel are disposed substantially parallel to each other so that the display electrodes and the address electrodes cross at right angles. In the opposed front and rear panels, the annular glass frit sealing portion (86) is sandwiched by the front panel (1) and the rear panel (2) as shown in FIG. 5. The opposed front panel (1) and the rear panel (2) may be held by a clip (70) or the like so as not to move thereafter (see FIG. 1(a)). The distance between the opposed front and rear panels (namely “gap size”) is preferably in the range of from 0.1 to 0.6 mm, more preferably from 0.3 to 0.6 mm, and still more preferably from 0.3 to 0.5 mm, while it may vary depending on the thickness of annular glass frit sealing portion and other factors. While the rear panel (2) has the partition walls (23) therein, the annular glass frit sealing portion (86) is higher than the partition walls (23) at the point in time before the sealing process is performed, and thus the top of each partition wall (23) does not touch the front panel (1) (see FIG. 5). As a result, there are provided gaps inside the panel, and therefore the introduced gas is allowed to flow through the gaps.

Subsequent to the step (iii) of the method of the present invention, the step (iv) is performed wherein the gas is introduced into the inner space of the opposed front and rear panels. Namely, the flow of the dry gas is supplied between the opposed front and rear panels. It is preferred that the flow of the dry gas is supplied between the opposed front and rear panels while heating the opposed front and rear panels. In other words, the dry gas is introduced under such a condition that the opposed front and rear panels are heated. The dry gas can be introduced via the gas inlet opening, as described above.

The heating of the opposed front and rear panels can be performed in a chamber (e.g. a furnace for heating or exhausting). It is preferable to heat the opposed front and rear panels in the furnace while supplying the gas, in which case the gas supply is commenced at a normal temperature. There is no restriction on the heating temperature as long as the undesired reaction is suppressed from occurring between the protective layer and impurity gas (impurity gas such as water or carbon dioxide) or as long as the denatured layer component is released from the protective layer (for example, impurities such as CO₃²⁻ or OH⁻ that have been contained in the protective layer is released therefrom). The heating temperature may be in the range of from about 350 to 450° C., for example.

It is preferred that the dry gas to be supplied has inertness or inactive with respect to the protective layer. As an inert gas, a nitrogen gas may be used, for example. A noble gas such as helium, argon, neon or xenon may also be used. It is particularly preferable to use no oxygen-containing gas since it effectively serves to prevent the protective layer from being carbonated, such carbonation being generally caused through a burning of the residual organic component in the inner space of the opposed panels. It is also preferred that the dry gas to be supplied includes very little moisture. For example, it is preferred that the water content of the dry gas to be supplied is 1 ppm or less. As used herein, “water content of the gas (ppm)” means the proportion of water or water vapor in the total volume of the gas (standard condition of 1 atmosphere at 0° C.) in terms of part per million, and represents a value measured by a conventional dew point meter. Since the nitrogen gas is expensive, the use of dry air makes the PDP production more cost effective. While the optimum flow rate of the gas depends on the panel size, number and size of the gas inlet openings, thickness of the glass frit sealing portion and size of surface irregularity of the glass frit sealing portion and other factors, it is roughly in the range of from 0.1 SLM to 10 SLM (SLM is a unit for expressing a volume (L) of the supplied gas per one minute in the standard condition). The insufficient flow rate of the gas may allow the outside air to intrude or an insufficient cleaning to occur, whereas the excessive flow rate of the gas may be disadvantageous in terms of not only the cost but also the deformation of the front and rear panels. In other words, too much flow rate of the dry gas can cause the front and rear panels to be deformed.

Although the top of the annular glass frit sealing portion is in contact with the substrate, the top of the annular glass frit sealing portion is not exactly flat and has surface irregularities measuring several tens to hundred micrometers. For example, there are small gaps due to the interface irregularities between the top of the annular glass frit sealing portion formed on the rear panel and the surface of the front panel. Accordingly, the dry gas introduced via the gas inlet opening can eventually be discharged through the gap between the annular glass frit sealing portion and the substrate (see “region M” shown in FIG. 3(a), for example). Alternatively, at least one exhausting groove may be formed in a part of the annular glass frit sealing portion so as to positively discharge the introduced gas through such groove.

According to the method of the present invention, the step (v) is performed together with the step (iv) of introducing the dry gas. The heating of the opposed front and rear panels upon the supply of the dry gas can cause the annular glass frit sealing portion to melt, and thereby the front and rear panels are sealed with each other so that the substantial gas supply into the space between the front and rear panels is ceased. More specifically, the front panel and the rear panel are heated while introducing the dry gas into the space formed between the opposed front and rear panel, and thereby the front panel and the rear panel are bonded together along their peripheries into airtight state. There is no restriction on the heating temperature upon the sealing treatment of the step (v) as long as the melting of the annular glass frit sealing portion is achieved. Such heating temperature may be a sealing temperature that is the same as those used in the conventional PDP production, for example in the range of from 400 to 500° C. The phrase “sealing temperature” refers to a temperature at which the front panel and the rear panel are sealed together airtight by a sealing material (i.e. glass frit material). Now the operation regarding the steps (v) and (iv) will be described below in detail. The gas supply is commenced at a normal temperature. Upon the gas supply, the opposed front and rear panels are heated in a furnace. When the temperature exceeds the softening point of the glass frit, the annular glass frit sealing portion softens and melts. Thereafter, the melted annular glass frit sealing portion gradually fills the gap formed between the sealing portion and the front panel (namely, the surface irregularity of the annular glass frit sealing portion is filled due to the melting thereof). The opposed front and rear panels are maintained in a temperature range in which the glass frit sealing portion is completely melted for several minutes to ten several minutes (for example, the panel temperature is kept in the temperature range of about 10 to 70° C. higher than the melting point of the glass frit), followed by a cooling treatment of the panels to harden the glass frit, and thereby the front panel and the rear panel are sealed with each other.

According to the method of the present invention, the dry gas is supplied so that the front and rear panels do not deform until the point in time when a softening point of the annular glass frit sealing portion is reached upon the heating thereof. The phrase “softening point” used in this specification and claims refers to a temperature at which the glass frit of the annular glass frit sealing portion softens. For example, the softening point may be about 430° C. According to the method of the present invention, the supply of the dry gas is stopped after the front and rear panels have been sealed with each other. The stop of the gas supply can prevent a internal pressure of the opposed panels to rising further, which leads to a prevention of the deformation of the front panel and the rear panel. More specifically, if the supply of the dry gas is continued even after the front and rear panels have been sealed, the introduced dry gas cannot escape from the inner space of the opposed panels and thereby increasing the internal pressure of the opposed panels, which leads to the deformation of the front and rear panels. To avoid this, according to the present invention, the supply of the dry gas is stopped after the front and rear panels have been sealed with each other.

After sealing, the space formed between the front and rear panels is evacuated to crease a vacuum atmosphere while maintaining the sealed front and rear panels at a temperature being somewhat lower than the sealing temperature (namely a temperature at which a solidification of the glass frit is maintained, and such temperature is for example 10 to 50° C. lower than the melting point of the glass frit).

After the vacuum atmosphere is created, the space formed between the front and rear panels is filled with the discharge gas. The pressure of the filled gas may be in the range of from about 30 Torr to 300 Torr. The discharged gas may be a mixture gas of Xe and Ne. Alternatively, the space may also be filled with Xe only, or a mixture gas of He and Xe. The evacuation and filling may be performed via the gas inlet opening that has been used for the introduction of the gas. That is, the space may be evacuated and subsequently filled with the discharge gas via the gas inlet opening through a valve switching operation. Such filling of the discharge space with the discharge gas is completed, and thereby the PDP is obtained.

### (Protective Layer Formed According to the Present Invention)

The protective layer, which also characterizes the present invention, will now be described in detail below. The protective layer (16) is preferably composed of a base film (16a) and aggregated particles (16b′), as shown in FIG. 2(b). The base film is formed on the dielectric layer (15). The aggregated particles (16b′), which consist of a plurality of crystal particles (16b) of magnesium oxide (MgO), is disposed on the base film (16a). As for the base film (16a), it is made of at least one metal oxide selected from among magnesium oxide (MgO), calcium oxide (CaO), strontium oxide (SrO) and barium oxide (BaO). More specifically, according to the present invention, the base film (16a) of the protective layer (16) is made of a metal oxide consisting of at least two oxides selected from among magnesium oxide (MgO), calcium oxide (CaO), strontium oxide (SrO) and barium oxide (BaO).

The base film (16a) may be formed by a thin film process using pellets of a oxide selected from among magnesium oxide (MgO), calcium oxide (CaO), strontium oxide (SrO) and barium oxide (BaO), or pellets prepared by mixing these oxides. As the thin film process, a known process such as an electron beam vapor deposition process, a sputtering process or an ion plating process may be used. The upper limit of pressure that can be practically used is about 1 Pa for the sputtering process, and about 0.2 Pa for the electron beam vapor deposition process (that is an example of vapor deposition processes). With regard to the atmosphere for the forming of the base film (16a), it is preferable to carry out the thin film process in a closed condition being isolated from the outside, in order to prevent the contact with the moisture and the adsorption of the impurities. By controlling the atmosphere in which the base film is formed, the base film (16a) made of the metal oxide with desired electron releasing characteristic is obtained.

The aggregated particles (16b′), which are composed of the crystal particles (16b) made of magnesium oxide (MgO) on the base film (16a), will now be described. The crystal particles (16b) can be produced by a gas phase synthesis process or a precursor calcining process. In the gas phase synthesis process, magnesium with purity of 99.9% or higher is heated in an inert gas atmosphere, and then a small amount of oxygen is introduced into the atmosphere. As a result, the magnesium is directly oxidized to form the crystal particles (16b) of magnesium oxide (MgO).

In the precursor calcining process, a precursor of magnesium oxide (MgO) is uniformly heated at a temperature as high as about 700° C. or higher, and is then gradually cooled down to produce the crystal particles (16b) of magnesium oxide (MgO). The precursor may be one or more kinds of compound selected from among magnesium alkoxide (Mg(OR)₂), magnesium acetylacetone (Mg(acac)2), magnesium hydroxide (Mg(OH)₂), magnesium carbonate (MgCO₂), magnesium chloride (MgCl₂), magnesium sulfate (MgSO₄), magnesium nitrate (Mg(NO₃)₂) and magnesium oxalate (MgC₂O₄). Some of these compounds may be in the form of hydrate, and in this regard such hydrate can be used in the present invention. The above compound is prepared so as to produce magnesium oxide (MgO) with purity of 99.95% or higher and preferably 99.98% or higher after being calcined. In a case where the compound contains alkaline metal or elements such as B, Si, Fe or Al as impurities with a concentration thereof higher than a certain level, an undesired fusing of particles or sintering may occur during the heat treatment, inhibiting a production of crystal particles of magnesium oxide (MgO) with high crystallinity. For this reason, it is necessary to take measures such as removing impurity elements from the precursor.

The crystal particles (16b) of magnesium oxide (MgO) produced by any one of the processed described above are dispersed into a solvent, and the resulting dispersion liquid is spread over the surface of the base film (16a) by spraying, screen printing, slit coating, electrostatic application process or the like. Thereafter the solvent of the dispersion liquid is removed by drying process, followed by a calcining process. As a result, the crystal particles (16b) of magnesium oxide (MgO) are fixed on the surface of the base film (16a).

The process of distributing and fixing the crystal particles (16b) of magnesium oxide (MgO) onto the surface of the base film (16a) is preferably performed at a low temperature of about 400° C. or lower, in order to suppress a reaction of the base film (16a) with impurities.

Furthermore, the protective layer characterizing the present invention will now be described in much more detail. According to the method of the present invention, the protective layer of the front panel is formed from a metal oxide consisting of at least two oxides selected from among magnesium oxide, calcium oxide, strontium oxide and barium oxide, said metal oxide having a peak diffraction angle between the minimum diffraction angle and the maximum diffraction angle which are selected among the diffraction angles given by respective ones of said oxides (more specifically respective ones of the metal oxides constituting the above metal oxide of the protective layer) with respect to some orientation plane in X-ray diffraction analysis. In this regard, it is preferable to form the base film (16a) of the protective layer from such metal oxide. In other words, the base film (16a) of the protective layer is formed from a metal oxide consisting of at least two oxides selected from among magnesium oxide(MgO), calcium oxide(CaO), strontium oxide(SrO) and barium oxide(BaO), said metal oxide having a peak diffraction angle between the minimum diffraction angle and the maximum diffraction angle which are selected among the diffraction angles given by respective ones of said oxides (more specifically respective ones of the metal oxides constituting the above metal oxide of the base film (16a)) with respect to a specific orientation plane in X-ray diffraction analysis.

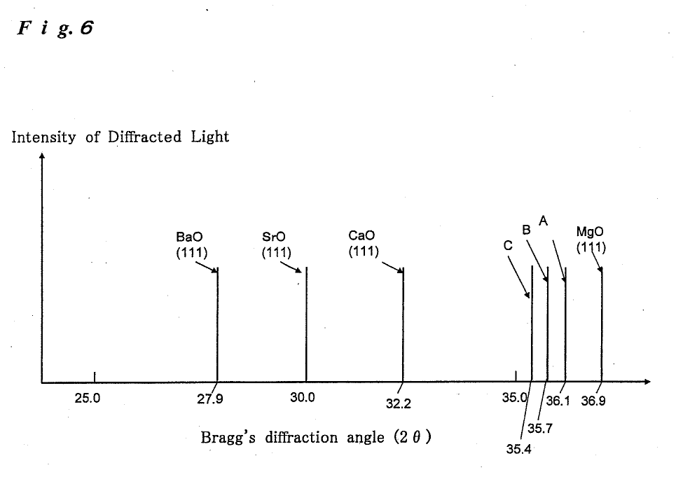

FIG. 6 is a diagram showing the result of X-ray diffraction analysis on the base film (16a) constituting the protective layer (16) of the PDP according to the embodiment of the present invention. FIG. 6 also shows the results of X-ray diffraction analysis conducted separately on magnesium oxide (MgO), calcium oxide (CaO), strontium oxide (SrO) and barium oxide (BaO).

In FIG. 6, Bragg's diffraction angle (20) is plotted along the horizontal axis and X-ray diffraction intensity is plotted along the vertical axis. The diffraction angle is shown by the unit of degrees, with 360 degrees meaning one full turn. The diffraction intensity is shown with arbitrary unit. In the diagram, a crystal orientation plane, which corresponds to specific orientation planes, is indicated in parentheses. As shown in FIG. 6, it can be seen that, with respect to the crystal orientation (111), calcium oxide (CaO) has a diffraction angle of 32.2 degrees, magnesium oxide (MgO) has a diffraction angle of 36.9 degrees, strontium oxide (SrO) has a diffraction angle of 30.0 degrees and barium oxide (BaO) has a diffraction angle of 27.9 degrees as a peak diffraction angle.

FIG. 6 also shows the result of X-ray diffraction analysis in a case of the base film (16a) made of a metal oxide consisting of the two oxides selected from magnesium oxide (MgO), calcium oxide (CaO), strontium oxide (SrO) and barium oxide (BaO). In FIG. 6, the result of X-ray diffraction analysis of the base film (16a) formed from magnesium oxide (MgO) and calcium oxide (CaO) is shown as “A”, the result of X-ray diffraction analysis of the base film (16a) formed from magnesium oxide (MgO) and strontium oxide (SrO) is shown as “B”, and result of X-ray diffraction analysis of the base film (16a) formed from magnesium oxide (MgO) and barium oxide (BaO) is shown as “C”.

As will be seen from the result of X-ray diffraction analysis shown in FIG. 6, the point A represents a peak at diffraction angle of 36.1 degrees between the diffraction angle of 36.9 degrees of magnesium oxide (MgO) that is the maximum diffraction angle among the individual oxides and the diffraction angle of 32.2 degrees of calcium oxide (CaO) that is the minimum diffraction angle among the individual oxides with respect to the crystal orientation plane (111) that is the specific orientation plane. Similarly, the point B and point C represent peaks at diffraction angles of 35.7 degrees and 35.4 degrees, respectively, between the maximum diffraction angle and the minimum diffraction angle among the individual oxides with respect to the crystal orientation plane (111).

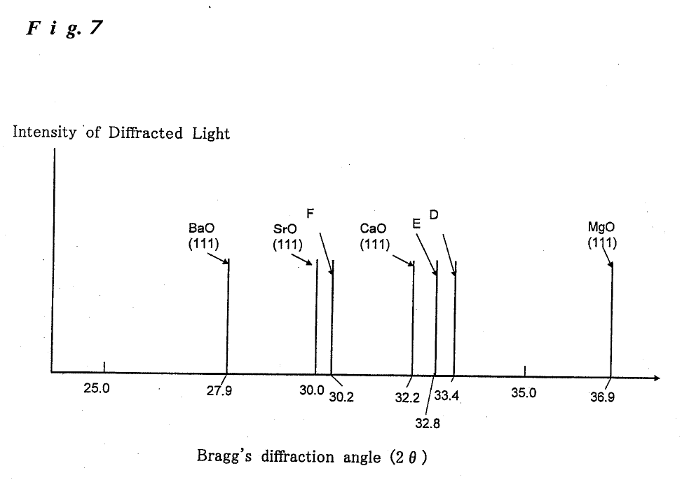

Similarly to FIG. 6, FIG. 7 shows the results of X-ray diffraction analysis in a case of the base film (16a) made of a metal oxide consisting of the three or more oxides selected from magnesium oxide (MgO), calcium oxide (CaO), strontium oxide (SrO) and barium oxide (BaO). In FIG. 7, the result of X-ray diffraction analysis of the base film (16a) formed from magnesium oxide (MgO), calcium oxide (CaO) and strontium oxide (SrO) is shown as “D”, the result of X-ray diffraction analysis of the base film (16a) formed from magnesium oxide (MgO), calcium oxide (CaO) and barium oxide (BaO) is shown as “E”, and the result of X-ray diffraction analysis of the base film (16a) formed from calcium oxide (CaO), strontium oxide (SrO) and barium oxide (BaO) is shown as “F”.

As will be seen from the results of X-ray diffraction analysis shown, point D represents a peak at a diffraction angle of 33.4 degrees between the diffraction angle of 36.9 degrees of magnesium oxide (MgO) that is the maximum diffraction angle among the individual oxides and the diffraction angle of 30.0 degrees of strontium oxide (SrO) that is the minimum diffraction angle with respect to the crystal orientation plane (111) that is the specific orientation plane. Similarly, point E and point F represent peaks at diffraction angles of 32.8 degrees and 30.2 degrees, respectively, between the maximum diffraction angle and the minimum diffraction angle among the individual oxides with respect to the crystal orientation plane (111).

As can be seen from above, the base film (16a) of the PDP protective layer of the present invention, regardless of whether it is formed from a metal oxide consisting of two or three individual oxides, has a peak diffraction angle between the minimum diffraction angle and the maximum diffraction angle which are selected among the diffraction angles given by respective ones of the metal oxides constituting the above metal oxide of the base film (16a) in a specific orientation plane in X-ray diffraction analysis.

While the crystal orientation plane (111) has been dealt with as the specific orientation plane in the above description, peak position of the metal oxide is similar to those described above also in a case where another crystal orientation plane is dealt with.

Calcium oxide (CaO), strontium oxide (SrO) and barium oxide (BaO) have depths with respect to the vacuum level in a shallow region compared to that of magnesium oxide (MgO). As a result, when electrons existing in the energy levels of calcium oxide (CaO), strontium oxide (SrO) and barium oxide (BaO) undergo transition to the base level of xenon (Xe) ion, it is expected that the number of electrons released by the Auger effect becomes larger than that of a case of transition from the energy level of magnesium oxide (MgO).

A metal oxide having the feature shown in FIG. 6 and FIG. 7 with regard to the result of X-ray diffraction analysis has energy level between those of the individual oxides that constitute them. As a result, the energy level of the base film (16a) also lies between those of the individual oxides, and is sufficient for the other electrons to acquire the energy enough to exceed the vacuum level and be released by the Auger effect.

Thus the base film (16a) provides better secondary electron releasing characteristic compared to the case of individual magnesium oxide (MgO), so that electric discharge sustaining voltage can be decreased. This means that the discharge voltage can be decreased and the PDP operating at a low voltage with high brightness can be realized when the partial pressure of xenon (Xe) used as the discharge gas is increased for increasing the brightness.

The electric discharge sustaining voltage of the PDP obtained with the method of the present invention when the constitution of the base film (16a) is altered will be described below. A sample A (the base film is formed from magnesium oxide and calcium oxide as the metal oxide), a sample B (the base film is formed from magnesium oxide and strontium oxide as the metal oxide), a sample C (the base film is formed from magnesium oxide and barium oxide as the metal oxide), a sample D (the base film is formed from magnesium oxide, calcium oxide and strontium oxide as the metal oxide) and a sample E (the base film is formed from magnesium oxide, calcium oxide and barium oxide as the metal oxide) were prepared as the sample of the present invention. A comparative example was prepared by forming the base film from magnesium oxide.

The electric discharge sustaining voltage measured on samples A to E was 90 for the sample A, 87 for the sample B, 85 for the sample C, 81 for the sample D and 82 for the sample E, relative to the value of the comparative example that was assumed to be 100.

Increasing the partial pressure of xenon (Xe) in the discharge gas from 10% to 15% causes brightness to increase by about 30%, while causing the electric discharge sustaining voltage to increase by about 10% in the comparative example where the base film (16a) is formed from magnesium oxide (MgO) only. In the PDP obtained with the method of the present invention, in contrast, the electric discharge sustaining voltage can be decreased by about 10 to 20% in any of the sample A, sample B, sample C, sample D and sample E, compared to the comparative example, thus making it possible to keep the electric discharge starting voltage within the range of normal operation thereby to realize the PDP that is capable of achieving high brightness while operating at a low voltage.

Calcium oxide (CaO), strontium oxide (SrO) and barium oxide (BaO) have high reactivity individually and are apt to react with impurities leading to a decrease in the electron releasing performance, although use of these metal oxides lowers the reactivity and forms such crystal structure that is less prone to the inclusion of impurities and oxygen defects. That is, use of calcium oxide (CaO), strontium oxide (SrO) and barium oxide (BaO) in the form of metal oxide suppresses electrons from being released excessively during the operation of the PDP, so as to obtain reasonable effect of electron releasing characteristic in addition to the double effects of low voltage operation and secondary electron releasing performance. The electric charge retaining performance is advantageous for ensuring reliable writing discharge by retaining wall electrons that have been accumulated during the initialization period and preventing writing failure from occurring during the writing period.

Now, the aggregated particles (16b′) composed of a plurality of crystal particles (16b) of magnesium oxide (MgO) deposited on the base film (16a) will be described in detail below. The aggregated particles (16b′) of magnesium oxide (MgO) have proved to have the effect of suppressing the delay in discharge during writing discharge and the effect of improving the temperature dependency of the delay in electric discharge, in experiments conducted by the inventors of the present invention. Accordingly, in the present invention, the aggregated particles (16b′) are disposed as the source of primary electrons that is required during the rise of the discharge pulse, by taking advantage of better primary electron releasing characteristic of the aggregated particles (16b′) than that of the base film (16a).

“Delay in electric discharge” is considered to be caused mainly by the shortage in the number of primary electrons, which serve as the trigger at the start of electric discharge, released from the surface of the base film (16a) into the discharge space. Therefore, in order to stabilize the supply of primary electrons into the discharge space, the aggregated particles (16b′) of magnesium oxide (MgO) are disposed in a dispersed manner over the surface of the base film (16a). This leads to the elimination of the delay in electric discharge, with abundant of electrons supplied in the discharge space during the rise of the discharge pulse. As a result, such a primary electron releasing characteristic enables it to operate the PDP at a high speed with good electric discharge response characteristic even during high definition display operation. The constitution wherein the aggregated particles (16b′) of metal oxide are disposed on the surface of the base film (16a) achieves the effect of suppressing the “delay in electric discharge” during writing discharge and the effect of improving the temperature dependency of the “delay in electric discharge”.

Thus the PDP obtained with the method of the present invention is capable of operating at a high speed at a low voltage even during high definition display operation and achieving high quality picture display while suppressing lighting failure, by the protective layer composed of the base film (16a) that has the double effects of low voltage operation and electric charge retaining, and the aggregated particles (16b′) of magnesium oxide (MgO) that have the effect of preventing the delay in electric discharge.

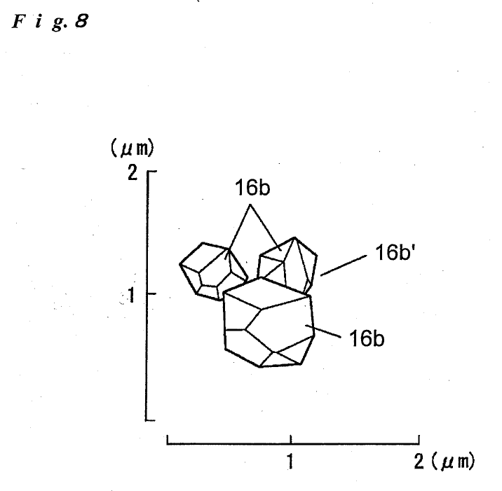

In a preferred embodiment of the present invention, the aggregated particles (16b′) composed of several crystal particles (16b) are dispersed on the base film (16a), so that a plurality of the aggregated particles are distributed so as to deposit substantially uniformly over the entire surface. FIG. 8 is an enlarged diagram showing the aggregated particles (16b′).

A shown in FIG. 8, the aggregated particles (16b′) are clusters of crystal particles (16b) with predetermined primary size that have been aggregated together. Thus the aggregated particles (16b′) take the form of clusters of the primary particles aggregated by the electrostatic attraction or van der Waals forces to be bonded together by an extraneous influence such as ultraviolet excitation to such an extent as part or whole thereof is in the state of the primary particles, not by a strong bonding force as a solid. Size of the aggregated particles is about 1 μm, and the crystal particles preferably have polyhedral shape that has seven or more faces such as dodecahedron or quadridecahedron.

Particle size of the primary particles regarding the crystal particles (16b) can be controlled by the conditions of forming the crystal particles (16b). In a case where the crystal particles (16b) are formed by calcining an MgO precursor such as magnesium carbonate or magnesium hydroxide, for example, particle size can be controlled by adjusting the calcining temperature and calcining atmosphere. While the calcining temperature may be set within a range of from 700 to 1,500° C., setting the calcining temperature at a relatively high level of 1,000° C. makes it possible to control the particle size to about 0.3 to 2 μm. Moreover, when the crystal particles (16b) are formed by heating an MgO precursor, the aggregated particles (16b′) can be obtained as a plurality of the primary particles are aggregated together in the formation process. /

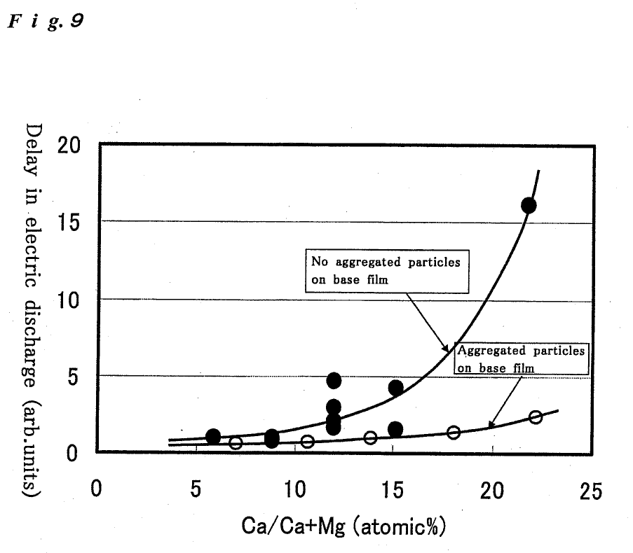

FIG. 9 shows the relationship between the delay in electric discharge and the calcium (Ca) concentration in the protective layer, in a case where the base film (16a) is formed from metal oxides of magnesium oxide (MgO) and calcium oxide (CaO) according to the embodiment of the present invention. The base film (16a) is formed from metal oxides of magnesium oxide (MgO) and calcium oxide (CaO), and the metal oxide is conditioned so that X-ray diffraction analysis on the surface of the base film (16a) shows a peak diffraction angle between the diffraction angle at which the peak of magnesium oxide (MgO) appears and the diffraction angle at which the peak of calcium oxide (CaO) appears. FIG. 9 shows a case where only the base film (16a) is provided as the protective layer, and a case a where the aggregated particles (16b′) are disposed on the base film (16a), and the delay in discharge is shown with reference to a case where the base film (16a) contains calcium oxide (CaO).

The electron releasing performance is an indicator of which value being higher indicates a larger number of released electrons, and is represented by the number of primary electrons released, which is determined by the surface condition and the type of gas. The number of primary electrons released can be determined by measuring the current of electrons released from the surface when the surface is irradiated with ion beam or electron beam, although it is difficult to evaluate the front panel surface of the PDP in non-destructive manner. Therefore, the method described in Japanese Patent Kokai Publication No. 2007-48733 was employed. Specifically, of the delay electric in charge, a value called the statistic delay period that indicates the aptness to electric discharge was measured, and the inverse of the value is integrated to give a value that corresponds to the number of primary electrons released and the line shape. This value is used in the evaluation. The delay in electric discharge refers to the time elapsed after the rising of the pulse till the electric discharge occurs. The delay in electric discharge is considered to be caused mainly by the difficulty of the primary electrons, which serve as the trigger at the start of discharge, to be released from the surface of the protective layer into the discharge space.

As is apparent from FIG. 9, the delay in electric discharge increases as the concentration of calcium (Ca) increases in the case where only the base film (16a) is provided, while the delay in electric discharge can be greatly decreased by disposing the aggregated particles (16b′) on the base film (16a), so that the delay in electric discharge hardly increases even when the concentration of calcium (Ca) increases.

Now, the results of experiment conducted to investigate the effects of the protective layer that has the aggregated particles (16b′) according to the embodiment of the present invention will be described below. First, PDPs having the base film (16a) of different constitutions and the aggregated particles (16b′) provided on the base film (16a) were fabricated as prototypes. Prototype 1 is a PDP having the protective layer (16) that consists of only the base film (16a) of magnesium oxide (MgO), prototype 2 is a PDP having the protective layer that consists of only the base film (16a) of magnesium oxide (MgO) doped with impurity such as Al, Si or the like, and prototype 3 is a PDP having the protective layer whereon primary particles of crystal particles (16b) of magnesium oxide (MgO) spread and deposited on the base film (16a) of magnesium oxide (MgO).

Prototype 4 is a PDP that is obtained by the method of the present invention, using sample A described previously as the protective layer. That is, the protective layer comprises the base film (16a) formed from metal oxides of magnesium oxide (MgO) and calcium oxide (CaO), and aggregated particles (16b′) composed of aggregated crystal particles (16b) deposited on the base film (16a) so as to be distributed substantially uniformly over the entire surface thereof. The base film (16a) is conditioned so as to show a peak diffraction angle between the minimum diffraction angle and the maximum diffraction angle of the peak observed in X-ray diffraction analysis of the oxide that constitutes the base film (16a). The minimum diffraction angle in this case is 32.2 degrees of calcium oxide (CaO) and maximum diffraction angle is 36.9 degrees of magnesium oxide (MgO), while the base film 91 shows a peak of diffraction at diffraction angle of 36.1 degrees.

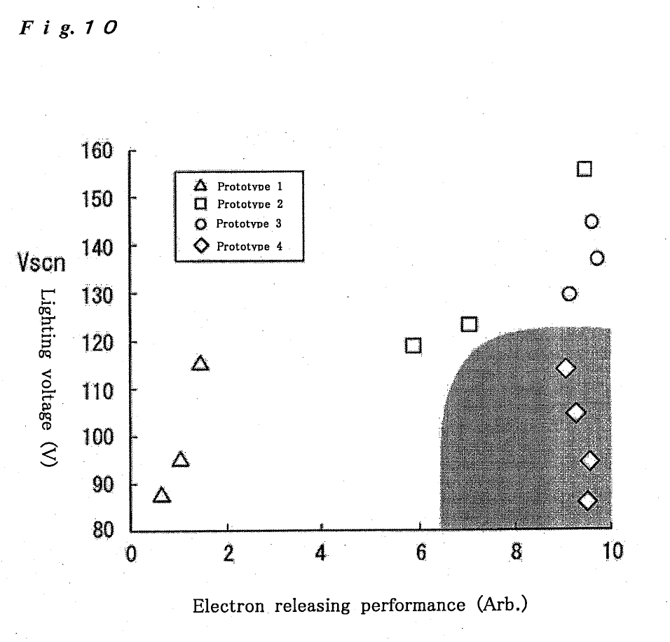

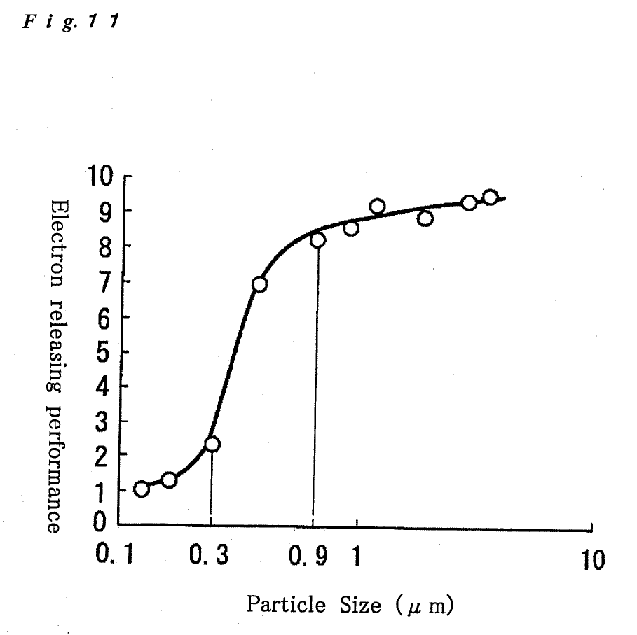

These PDPs were evaluated for the electron releasing performance and the electric charge retaining performance. The results are shown in FIG. 10. The electron releasing performance was evaluated by the method described previously, and the electric charge retaining performance was evaluated in terms of the voltage applied to the scan electrode (hereinafter referred to a Vscn lighting voltage) that is required for suppressing the release of electric charges when produced as the PDP. A lower Vscn lighting voltage means higher charge retaining capability. This means that components having lower withstanding voltage and/or lower capacity can be used for the power supply and electric components when designing the PDP. Currently commercialized products use semiconductor elements such as MOSFET that have withstanding voltage of about 150 V for applying the scan voltage to the panel, while it is desired to suppress the Vscn lighting voltage to about 120 V or lower in consideration of variation attributed to the temperature.

As can be seen from FIG. 10, in the case of prototype 4 that was made by spreading the aggregated particles (16b′) formed from aggregated single crystal particles (16b) of magnesium oxide (MgO) deposited on the base film (16a) of the embodiment of the present invention so as to be distributed substantially uniformly over the entire surface thereof, the Vscn lighting voltage can be controlled to 120 V or lower in the evaluation of the electric charge retaining performance and, in addition, far higher electron releasing characteristic can be achieved than that of prototype 1 of which protective layer was formed from magnesium oxide (MgO) only.

Electron releasing capability and charge retaining capability of the protective layer of the PDP are generally incompatible with each other. For example, electron releasing performance may be improved by changing the film forming conditions for the protective layer or doping the protective layer with impurity such as Al, Si or Ba, although it results in an increase in the Vscn lighting voltage as the side effect.

The PDP of prototype 4 according to the embodiment of the present invention shows the electron releasing performance 8 times higher than that of prototype 1 of which protective layer was formed from magnesium oxide (MgO) only, and achieves the charge retaining capability with Vscn lighting voltage of 120 V or lower. This is advantageous for the PDP that is designed with an increasing number of scan lines for higher definition display and smaller cell size, thus making it possible to meet the requirements of the electron releasing capability and the charge retaining capability at the same time and decrease the delay in electric discharge, thereby achieving higher quality pictures.

Now, the particle size of the crystal particles (16b) will be described in detail below. In the description that follows, particle size means the mean particle size and the mean particle size means the accumulated volume mean particle size (D50).

FIG. 11 shows the results of experiment conducted to investigate the electron releasing performance of prototype 4 of the present invention shown in FIG. 10 by changing the particle size of the crystal particles (16b). The particle size of the crystal particles (16b) shown in FIG. 11 was measured by observing the crystal particles under SEM. As shown in FIG. 11, small particle size of about 0.3 μm leads to low electron releasing performance, while particle size of about 0.9 μm or larger leads to high electron releasing performance.

In order to increase the number of electrons released in the discharge cell, it is desirable that there are more crystal particles (16b) per unit area of the base film. According to the experiment conducted by the inventors of the present application, however, it was found that crystal particles placed on a portion that corresponds to the top of the partition wall of the rear panel which makes contact with the protective layer of the front panel damage the top of the partition wall, resulting in the broken chips falling onto the phosphor layer and making the cell unable to normally turn on and off. Since the damage on the top of the partition wall is unlikely to occur if there is no crystal particles (16b) on the top of the partition wall, probability of the partition wall to be damaged become higher when the number of crystal particles (16b) deposited increases. In line with these considerations, probability of the partition wall to be damaged sharply increases when the particle size of the crystal particles increases to about 2.5 μm, and probability of the partition wall can be kept relatively low the particle size the of crystal particles is smaller than 2.5 μm.

As described above, it was found that the methods of the present invention described above can be stably achieved when the crystal particles (16b) with particle size in a range of from 0.9 μm to 2 μm are used in the protective layer in the method of the present invention. While the case of using the crystal particles (16b) of magnesium oxide (MgO) has been described above, similar effects can be achieved also by using other crystal particles of oxides of metals such as Sr, Ca, Ba and Al that have high electron releasing performance similarly to that of magnesium oxide (MgO). This means that the crystal particles are not limited to magnesium oxide (MgO).

### (Preferred Embodiment of Method of the Present Invention)

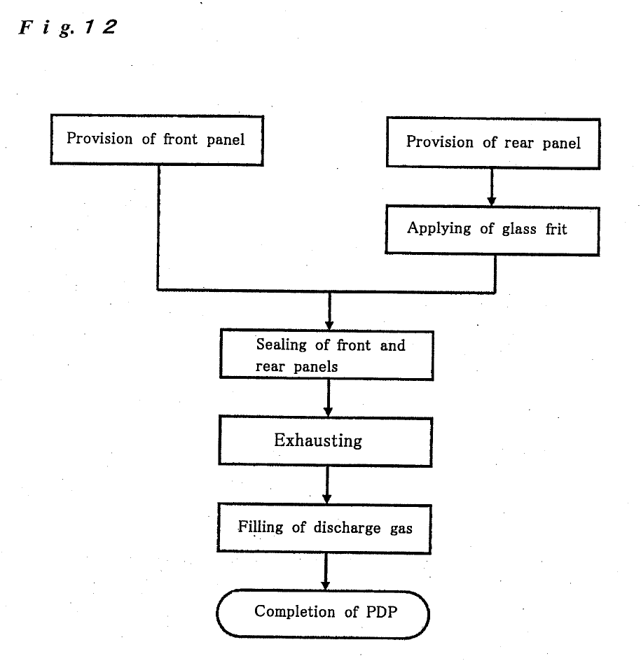

With reference to FIGS. 12 to 14, a preferred embodiment of the method of the present invention will be described below. the present invention is characterized in that the protective layer is formed from a metal oxide comprising at least two oxides selected from among magnesium oxide, calcium oxide, strontium oxide and barium oxide wherein said metal oxide has a peak diffraction angle between the minimum diffraction angle and the maximum diffraction angle which are selected among the diffraction angles given by respective ones of said at least two oxides in a specific orientation plane in the X-ray diffraction analysis thereof. Due to this characteristic of the present invention, the electric discharge starting voltage of the panel can be decreased and the delay in electric discharge can be decreased, which leads to an achievement of a stable electric discharge. However, the above metal oxide of the protective layer is highly reactive with water and impurity gas such as carbon dioxide. Namely, the above metal oxide of the protective layer may easily react with water and carbon dioxide. This means that the electric discharge characteristic may be deteriorated, thus resulting in variation in the electric discharge characteristic among the discharge cells. Accordingly, in the present invention, the dry gas is introduced via a through hole of the rear panel (i.e. the through hole being open into the discharge space) so as to generate a positive pressure in the discharge space during the sealing process, and thereby suppressing the reaction between the protective layer and the impurity gas during the production of the PDP. In this regard, the dry gas has an effect of purging the impurity gas that has been dissociated from the surface of the protective layer to the outside of the panel, while on the other hand, the flow of the dry gas may cause the front panel and the rear panel to deform and the discharge space to swell. This swelling of the discharge space during the sealing and exhausting process causes an unevenness in the flow state of dry gas, which in turn causes an unevenness in the adsorbed impurity gas of the protective layer surface, and thus resulting in an unevenness in the drive voltage and/or the display brightness over the display surface region. Accordingly, in the present invention, the supplying of the dry gas is performed together with the sealing process to generate a positive pressure in the discharge space while preventing a deformation of the front panel and the rear panel, which will lead to an achievement of suppression of the unevenness in the display brightness. In particular, the dry gas is performed until the point in time when the softening point of the annular glass frit sealing portion is reached.

FIG. 12 is a flow chart showing the process of producing the PDP. As shown in FIG. 12, the PDP is obtained through a front panel forming process, a rear panel forming process, a glass frit application process, a sealing process, an exhausting process and a discharge gas supply process. In the glass frit application process, a glass frit is applied as a sealing member onto the outside of the display region of the rear panel formed in the rear panel forming process and then a preliminary calcining is performed by heating it to about 350° C. to remove a resin component therefrom. In the sealing process, the opposed front and rear panels are sealed with each other. In the exhausting process, the gas is purged or exhausted from the discharge space formed between the opposed front and rear panels. In the discharge gas supply process, the discharge gas consisting mainly of Ne and Xe is introduced into the discharge space of vacuum atmosphere.

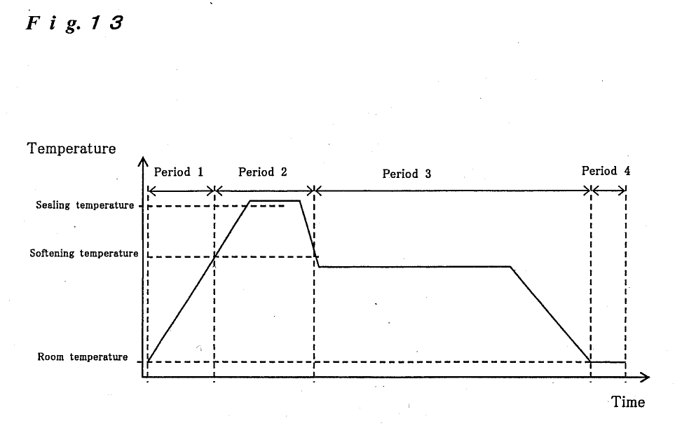

FIG. 13 is a diagram showing an example of temperature profile in the sealing process and the exhausting process according to the embodiment of the present invention.

Details of the profiles of the sealing process, the exhausting process and the discharge gas supply process will now be described. For the convenience of description, the sealing process, the exhausting process and the discharge gas supply process are divided into four periods in terms of the temperature as follow (see FIG. 13):
Period 1: A period of raising the temperature from the room temperature to the softening point;
Period 2: A period of raising the temperature from the softening point to the sealing temperature, and thereafter maintaining this temperature for a predetermined period of time, and then lowering the temperature to the softening point (sealing process is performed during the periods 1 and 2);
Period 3: A period in which the temperature is maintained at a level near or slightly lower than the softening point for a predetermined period of time, followed by being lowered to the room temperature (exhausting process is performed during the period 3); and
Period 4: A period after the room temperature has been reached (discharge gas supply process is performed during the period 4).

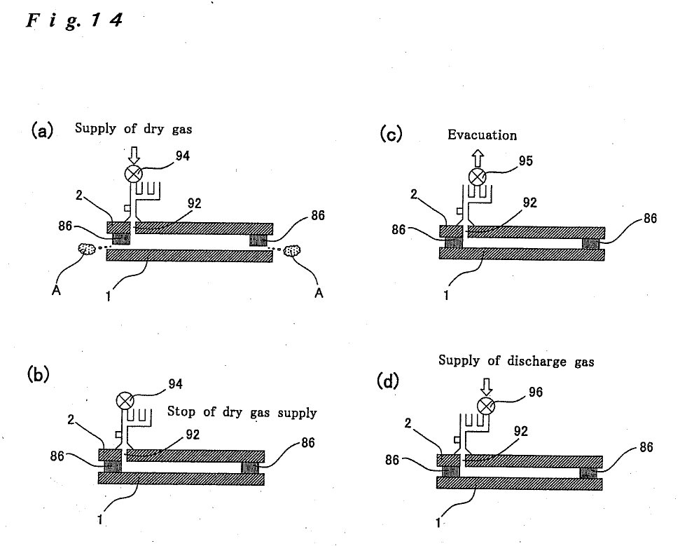

FIG. 14 schematically shows some steps regarding the panel producing method of the present invention. FIG. 14(a) to FIG. 14(d) show the gas flows within the panel during the periods 1 through 4, respectively. In FIG. 14, reference numeral 86 denotes a glass frit that has been applied onto the periphery of the rear panel wherein the applied glass frit serves as a sealing member. Reference numeral 92 denotes a through hole (i.e. “gas inlet opening”) formed in the glass substrate of the rear panel 2. The through hole 92 is formed in the rear-sided glass substrate so as to open into the discharge space. Reference numerals 94 to 96 denote valves, respectively.

First, the front panel and the rear panel are opposed to each other and aligned so that the display electrodes and the address electrodes face each other and cross at right angles. As shown in FIG. 14(a), the valve 94 is opened so as to supply the dry gas via the through hole 92 into the internal space of the opposed front and rear panels. Upon the supply of the dry gas, the heater is turned on to raise the internal temperature of the heating furnace in which the front and rear panels are provided.

As shown by the reference numeral A, the dry gas supplied into the opposed front and rear panels is forced to leak from the gap between the glass frit 86 formed on the rear panel and the front panel 1 to the outside of the panels. For example, the dry gas may be a dry nitrogen gas with a dew point of −45° C. or lower, and the flow rate thereof may be about 70 sccm/minute (Period 1).

When the internal temperature of the heating furnace reaches the softening point of the glass frit 86, then the valve 94 is closed to stop the supply of dry nitrogen gas as shown in FIG. 14(b).

Subsequently the internal temperature of the heating furnace is raised to the sealing temperature or higher. Thereafter, the internal temperature of the heating furnace is maintained at the sealing temperature or higher for a predetermined period of time (for example, for 30 minutes). During this period, the glass frit 86 is allowed to melt so that the melted the glass frit 86 has a slight fluidity, and thereby the front panel and the rear panel are sealed with each other.

Subsequently, the heater is turned off to lower the internal temperature of the heating furnace to fall below softening point (Period 2).

The exhausting process is the step of purging or exhausting the gas from the internal space of the opposed front and rear panels. In this regard, when the internal temperature of the heating furnace reaches the softening point or lower, the valve 95 is opened so as to purge or exhaust the internal gas via the through hole 92 and a glass tube as shown in FIG. 14(c). The Purging or exhausting of the gas is continued while keeping the internal temperature of the heating furnace by controlling the heater for a predetermined period of time.

Then the heater is turned off to lower the internal temperature of the heating furnace to the room temperature, while purging or exhausting the gas (Period 3).

The discharge gas supply process is the step of supplying the discharge gas consisting mainly of Ne and Xe into the discharge space of vacuum atmosphere. In this regard, after the internal temperature of the heating furnace reaches the room temperature, the valve 95 is closed and the valve 96 is opened so as to supply the discharge gas via the through hole 92 till a predetermined internal pressure of the discharge space is provided, as shown in FIG. 14(d).

According to this embodiment, the discharge gas is preferably a mixture of 10% Xe and 90% Ne with a pressure of 6×10⁴ Pa. However, the discharge gas is not limited to this composition. As the discharge gas, 100% Xe gas may be used.

Finally, the glass tube is heated to seal (Period 4), and thereby the PDP can be obtained.

In a case the dry nitrogen gas was introduced at a flow rate of 70 sccm/minute in the period of raising the internal temperature of the furnace from the room temperature to the softening point (period 1) during the sealing step, a pressure difference between the inside of the opposed front and rear panels and the outside thereof was 70 Pa. In this regard, the PDP thus produced showed an excellent uniformity of the panel characteristics (e.g. excellent uniformity of sustain voltage and brightness) over the display surface region.

As described with respect to the above embodiment, the sealing process is carried out while forcing the dry gas to flow via the through hole of the rear-sided glass substrate (i.e. through hole being open into the discharge space) so as to generate a positive pressure of the discharge space, preventing the front and rear panels from deforming until the point in time when the softening point of the sealing member is reached. As a result, it is made possible to prevent the electric discharge characteristics of the discharge cells from deteriorating locally in the panel, and thereby suppressing the electric discharge characteristics from varying among the discharge cells, which in turn leads to an achievement of the production of PDP with the protective layer of excellent electric discharge characteristics.

Although a few embodiments of the present invention have been hereinbefore described, the present invention is not limited to these embodiments. It will be readily appreciated by those skilled in the art that various modifications are possible without departing from the scope of the present invention. For example, the following modifications are possible:

The dielectric layer formed on the front panel may also have two-layered structure composed of a first dielectric layer and a second dielectric layer. In this case, it is preferable that the first dielectric layer is formed from a dielectric material that contains 20 to 40% by weight of bismuth oxide (Bi₂O₃), 0.5 to 12% by weight of at least one kind selected from among calcium oxide (CaO), strontium oxide (SrO) and barium oxide (BaO) and 0.1 to 7% by weight of at least one kind selected from among molybdenum oxide (MoO₃), tungsten oxide (WO₃), cerium oxide (CeO₂) and manganese dioxide (MnO₂). Instead of molybdenum oxide (MoO₃), tungsten oxide (WO₃), cerium oxide (CeO₂) and manganese dioxide (MnO₂), 0.1 to 7% by weight of at least one kind selected from among copper oxide (CuO), chromium oxide (Cr₂O₃), cobalt oxide (Co₂O₃), vanadium oxide (V₂O₇) and antimony oxide (Sb₂O₃) may be contained. Also in addition to the components described above, such a composition that does not contain the element lead may be employed as 0 to 40% by weight of zinc oxide (ZnO), 0 to 35% by weight of boron oxide (B₂O₃), 0 to 15% by weight of silicon oxide (SiO₂) and 0 to 10% by weight of aluminum oxide (Al₂O₃). A paste material for the first dielectric layer having such a composition as described above is applied to the front-sided glass substrate by a die coating process or screen printing process so as to cover the display electrodes and then is dried, followed by calcining thereof at a temperature of from 575° C. to 590° C. that is a little higher than the softening point of the dielectric material, and thereby the first dielectric layer is finally formed.

The second dielectric layer is preferably formed from a material that contains 11 to 20% by weight of bismuth oxide (Bi₂O₃), 1.6 to 21% by weight of at least one kind selected from among calcium oxide (CaO), strontium oxide (SrO) and barium oxide (BaO) and 0.1 to 7% by weight of at least one kind selected from among molybdenum oxide (MoO₃), tungsten oxide (WO₃) and cerium oxide (CeO₂). Instead of molybdenum oxide (MoO₃), tungsten oxide (WO₃) and cerium oxide (CeO₂), 0.1 to 7% by weight of at least one kind selected from among copper oxide (CuO), chromium oxide (Cr₂O₃), cobalt oxide (Co₂O₃), vanadium oxide (V₂O₇), antimony oxide (Sb₂O₃) and manganese dioxide (MnO₂) may be contained. Also in addition to the components described above, such a composition that does not contain the element lead may be employed as 0 to 40% by weight of zinc oxide (ZnO), 0 to 35% by weight of boron oxide (B₂O₃), 0 to 15% by weight of silicon oxide (SiO₂) and 0 to 10% by weight of aluminum oxide (Al₂O₃). A paste for the second dielectric layer having such a composition as described above is applied to the first dielectric layer by the screen printing process or die coating process and then is dried, followed by calcining thereof at a temperature of from 550° C. to 590° C. that is a little higher than the softening point of the dielectric material, and thereby the second dielectric layer is finally formed. The PDP produced in this way is less likely to suffer from yellowing of the front glass substrate even when silver (Ag) is used in the display electrodes. Moreover, no gas bubble is generated in the dielectric layer, so that a high resistance to the dielectric breakdown phenomenon is achieved (namely, even when a high voltage is applied, there is occurred no “dielectric breakdown phenomenon” in the dielectric layer).

The gas supply of the step (iv) may also be carried out via a groove formed in the annular glass frit sealing portion. In this case, a plurality of gas inlet grooves (92b) may be formed in the annular glass frit sealing portion (86) (see FIG. 3(b)). For example, the gas inlet grooves (92b) can be formed by partially removing or cutting off the annular glass frit sealing portion. Alternatively, the gas inlet grooves (92b) can be formed by intermittently applying the glass frit material. The size La (see FIG. 3(b)) of the gas inlet grooves (92b) may be for example in the range of roughly from 0.1 to 5 mm, and pitch Lp (see FIG. 3(b)) of the gas inlet grooves (92b) may be for example in the range of roughly from 50 to 500 mm while it may vary depending on the substrate size or other factors. Similarly to the gas inlet opening described previously, it is preferable that the plurality of the gas inlet grooves are disposed along the longer side of the front panel (1) or the rear panel (2). As for the embodiment of the gas inlet grooves, the gas inlet grooves are gradually blocked as the annular glass frit sealing portion is softened and melted during the sealing process. Eventually the gas inlet grooves are completely blocked, and thereby automatically or spontaneously ceasing the gas supply into the space formed between the front and rear panels. The automatic or spontaneous cease of the gas supply during the sealing process means that the dry gas consumption can be minimized.

### INDUSTRIAL APPLICABILITY

The PDP obtained by the method of the present invention has a satisfactory service life of the panel, and thus it is not only suitable for household use and commercial use, but also suitable for use in other various kinds of display devices. The present invention is particularly advantageous for producing a PDP with a higher picture quality and a lower power consumption.

CROSS REFERENCE TO RELATED PATENT APPLICATION

The disclosure of Japanese Patent Application No. 2009-116420 filed May 13, 2009 including specification, drawings and claims is incorporated herein by reference in its entirety.

What is claimed is:

1. A method for producing a plasma display panel, the method comprising:
(i) preparing a front panel and a rear panel, the front panel being a panel wherein an electrode A, a dielectric layer A and a protective layer are formed on a substrate A, and the rear panel being a panel wherein an electrode B, a dielectric layer B, a partition wall and a phosphor layer are formed on a substrate B;
(ii) applying a glass frit material onto a peripheral region of the substrate A or B to form an annular glass frit sealing portion;
(iii) opposing the front and rear panels with each other such that the annular glass frit sealing portion is interposed therebetween;
(iv) supplying a dry gas into a space formed between the opposed front and rear panels; and
(v) melting the annular glass frit sealing portion to cause the front and rear panels to be sealed wherein, in the step (i), the protective layer of the front panel is made from a metal oxide comprising at least two oxides selected from among magnesium oxide, calcium oxide, strontium oxide and barium oxide, said metal oxide having a peak between the minimum diffraction angle and the maximum diffraction angle which are selected among the diffraction angles given by respective ones of said at least two oxides in a specific orientation plane in X-ray diffraction analysis; and
the step (v) is performed together with the step (iv) wherein the dry gas is supplied such that the front and rear panels do not deform, until the point in time when a softening point of the annular glass frit sealing portion is reached.

2. The method according to claim 1 wherein, in the step (iv), the dry gas is supplied so that a positive pressure of from 0 (excluding 0) to 350 Pa is generated in the space formed between the opposed front and rear panels.

3. The method according to claim 1 wherein the dry gas is at least one kind of gas selected from the group consisting of inert gas, noble gas and dry air.

4. The method according to claim 1 wherein, in the step (iv), the dry gas is supplied via an opening of the front panel or the rear panel.
